(19) United States
(12) Patent Application Publication
(10) Pub. No.: US 2003/0221685 A1
(43) Pub. Date: Dec. 4, 2003

(54) Flat chisel

(76) Inventors: Marco Lang, Ravensburg (DE); Franc Koljaka, Bergamo (IT); Cristian Falchetti, Bergamo (IT)

Correspondence Address: VENABLE, BAETJER, HOWARD AND CIVILETTI, LLP, P.O. BOX 34385, WASHINGTON, DC, 20043-9998, US

(21) Appl. No.: 10/375,679

(22) Filed: Feb. 28, 2003

(30) Foreign Application Priority Data
Feb. 28, 2002 (DE) 102 08 627.3

(51) Int. Cl. B28D 1/26

(52) U.S. Cl. 125/41

(57) ABSTRACT

The invention relates to a flat chisel (2), in particular an insertion chisel for power-driven rotary hammers for working stone, having a chisel head (3) which has a main lip (7) disposed transversely to a chisel longitudinal axis (x), a front and a rear striking face (10, 11), and at least one side face (12, 13) connecting the striking face (10, 11). In this case, an approximately concave and/or convex and/or bent and/or undulating profile of at least one lip (7, 14, 15) is provided.

The invention relates to a flat chisel according to the preamble of claim 1.

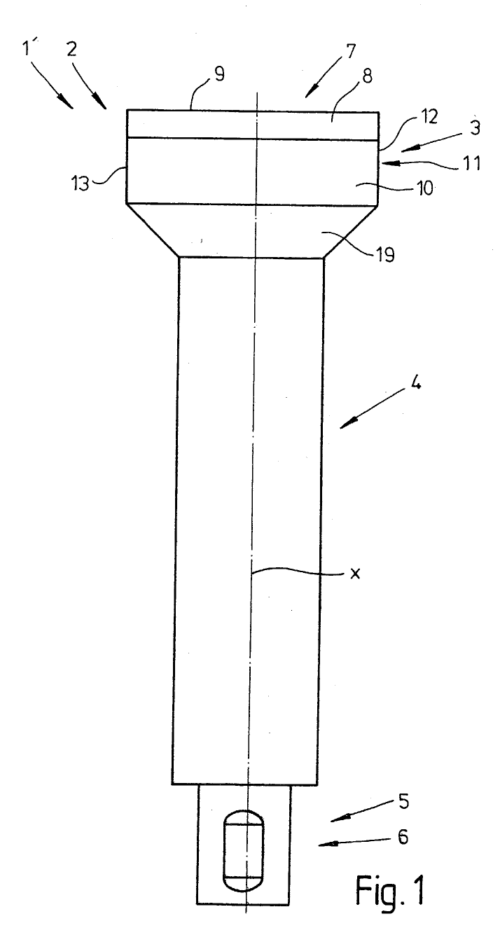

Such flat chisels are used when working stone, in particular masonry, in order to produce, for example, apertures, channels and slots. Flat chisels whose main lip is arranged transversely to a chisel longitudinal axis and has a rectilinear profile (see FIG. 1) are known from the prior art. Such flat chisels, when working the stone or when applied again, tend to drift away from the desired position along the profile of the main lip.

The object of the invention is to develop a flat chisel which does not tend to drift very much from a predetermined position laterally along the cutting edge. Furthermore, the object is to counteract lateral jamming of the flat chisel in the stone to be worked.

The object, in combination with the preamble of claim 1, is achieved according to the invention by the characterizing features of claim 1. Advantageous and expedient developments are specified in the subclaims.

The flat chisel according to the invention has a main lip and/or a side face designed as a side lip, said main lip and/or side face having a concave and/or convex and/or bent profile. Due to its crescent-shaped or wedge-shaped profile, the main lip, in the case of virtually any surface form of the material to be worked, engages on the latter first of all in an approximately point-like manner and is thereby centered in the predetermined position. This counteracts drifting or slipping of the chisel from the working position aimed at. In the region of the side faces, full-surface contact of the side lips is avoided due to the design of the side lips with a projecting or set-back profile of the cutting edges. During deep penetration, this leads to the avoidance of friction over a large area with the material to be worked and enables the chisel to be oriented again more easily to the desired working direction. Due to the reduced friction, a greater proportion of the energy introduced is available for the penetration of the chisel into the material to be worked.

The term “flat chisel” is intended to refer to a chisel having an elongated cutting edge which runs essentially perpendicularly to a chisel longitudinal axis or transversely to a striking direction.

According to an advantageous design of the subject matter of the invention, at least one side lip merges into the main lip. This avoids a lip-free region, at which jamming of the chisel with the material to be worked may occur. In addition, the lips stabilize one another.

An advantageous design of the subject matter of the invention provides for the cutting edges of the main lip and of the side lip to be arranged in a common plane. As a result, transverse loading of the lips or cutting edges during the penetration or withdrawal of the flat chisel from the material is largely avoided.

Due to an embodiment of the main lip and/or side lip which is gabel-shaped in cross section, the flat chisel is suitable for the most varied applications and setting angles.

By means of a ramp-shaped design of the main lip and/or side lip, it is possible to realize particularly pointed lips which promote perpendicular penetration into the material to be worked. Furthermore, lips of such a design enable the chisel to be applied to the material to be worked at an especially small angle.

Further details of the invention are described in the drawing with reference to schematically shown exemplary embodiments. The figures are partly CAD illustrations in which the chisels are shown by grid lines. In this case, hidden edges are also shown as solid lines.

In the drawing:

FIG. 1 shows a side view of a chisel known from the prior art,

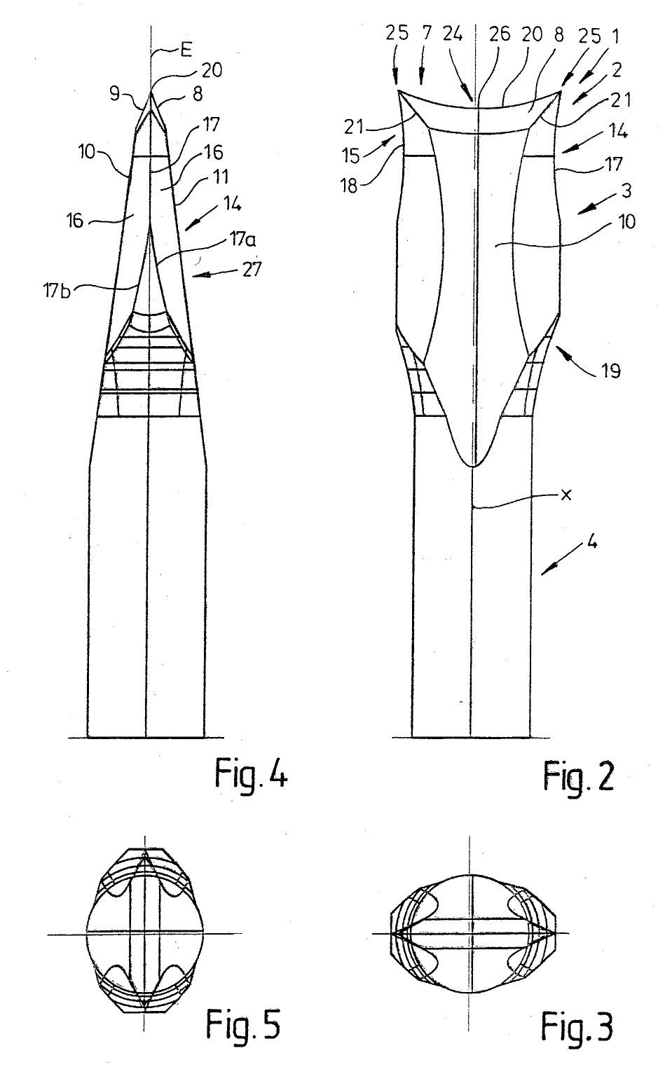

FIG. 2 shows a partial view of a chisel according to the invention,

FIG. 3 shows a plan view of the chisel shown in FIG. 2,

FIG. 4 shows a side view from the right of the chisel shown in FIG. 2,

FIG. 5 shows a plan view of the chisel shown in FIG. 4,

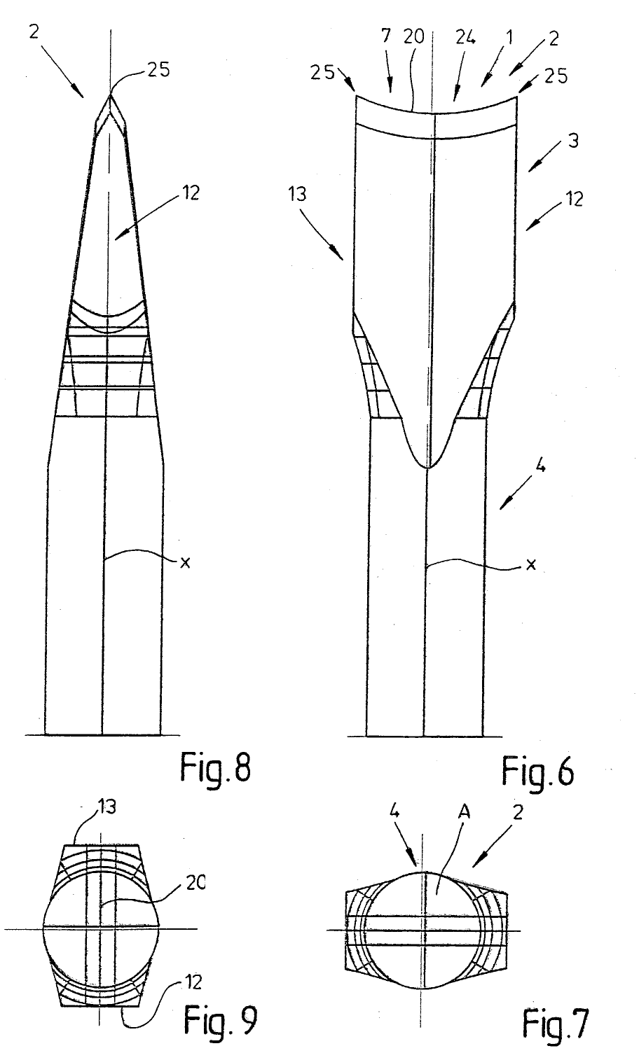

FIG. 6 shows a partial view of a second chisel,

FIG. 7 shows a plan view of the chisel shown in FIG. 6,

FIG. 8 shows a side view from the right of the chisel shown in FIG. 6,

FIG. 9 shows a plan view of the chisel shown in FIG. 8,

FIG. 10 shows a partial view of a third chisel,

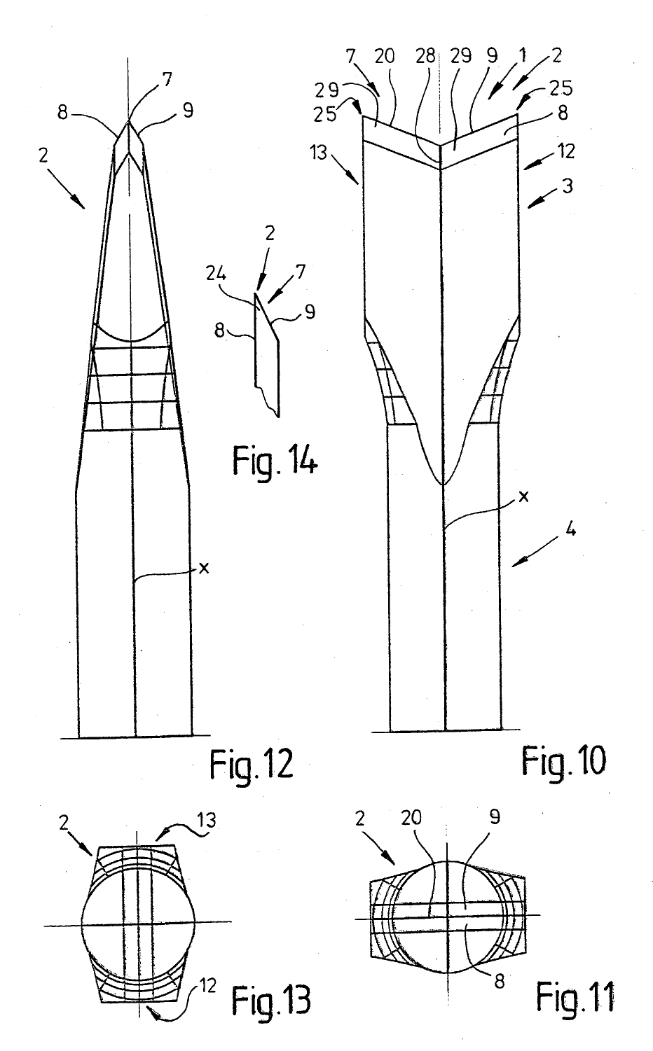

FIG. 11 shows a plan view of the chisel shown in FIG. 10,

FIG. 12 shows a side view from the right of the chisel shown in FIG. 10,

FIG. 13 shows a plan view of the chisel shown in FIG. 12, and

FIG. 14 shows a side view of a ramp-shaped lip.

Shown in FIG. 1 is a chisel 1′ which is known from the prior art, is designed as a flat chisel 2 and essentially comprises a chisel head 3, a chisel shank 4 and a clamping shank 5 or insertion end. The clamping shank 5 is an “SDS-plus clamping shank” 6 which serves for coupling to power-driven rotary hammers. Such chisels are also referred to as insertion chisels. Arranged on the chisel head 3 perpendicularly to a chisel longitudinal axis x is a main lip 7, which merges via a front cutting face 8 and a rear cutting face 9 into a front striking face 10 and a rear striking face 11. Side faces 12, 13 of the chisel head 3 connect the striking faces 10, 11. The chisel head 3 merges into the chisel shank 4 in a transition region 19.

FIG. 2 shows a partial view of a chisel 1 according to the invention, which is designed as a flat chisel 2. Of the flat chisel 2, only a chisel head 3 and part of a chisel shank 4 are shown in this view. The chisel head 3 has a main lip 7 with a cutting edge 20 formed by cutting faces 8, 9 meeting one another. Adjoining the cutting faces 8, 9 are striking faces 10, 11, which merge into the chisel shank 4 in a transition region 19. The cutting edge 20 runs concavely relative to a clamping shank (not shown). The main lip 7 forms a type of crescent 24 which ends in tips 25 and is intersected by a chisel longitudinal axis x at a low point 26. Along separating edges 21, the main lip 7 merges into side lips 14, 15 having cutting edges 17, 18, which are likewise of concave design and run in such a way as to be bent toward the chisel longitudinal axis x.

FIG. 3 shows a plan view of the flat chisel shown in FIG. 2. In FIG. 4, this flat chisel is shown in a side view from the right. Cutting faces 16 of a side lip 14 fork in the direction of a clamping shank (not shown). A cutting edge 17 of the side lip 14 therefore divides into two cutting edges 17a, 17b in a bottom region 27. The cutting edge 17 and the main lip 20 lie in a common plane E. FIG. 5 shows a plan view of the flat chisel shown in FIG. 4.

FIG. 6 shows a partial view of a second chisel 1 or flat chisel 2, of which only a chisel head 3 and part of the chisel shank 4 are shown. In analogy to the flat chisel shown in FIG. 2, a main lip 7 or its cutting edge 20 runs concavely and forms a type of crescent 24. The crescent 24 is oriented symmetrically to a longitudinal center axis x of the flat chisel 2 and runs out into side faces 12, 13. The main lip 7 ends in tips 25. No side lips are formed on the side faces 12, 13.

FIG. 7 shows a plan view of the flat chisel 2 shown in FIG. 6. The flat chisel 2 has a chisel shank 4 with a circular cross section A.

FIG. 8 shows a side view from the right of the flat chisel 2 shown in FIG. 6. FIG. 9 shows a plan view of the flat chisel 2 shown in FIG. 8.

FIG. 10 shows a partial view of a chisel 1 or flat chisel 2, of which a chisel head 3 and part of the chisel shank 4 are shown. A main lip 7 and its cutting edge 20 are designed in a V shape. Cutting faces 8, 9 of the main lip 7 are separated into partial cutting faces 29 along a chisel longitudinal axis x by a separating edge 28. Tips 25 are formed at the transition of the main lip 7 to side faces 12, 13.

FIG. 11 shows a plan view of the flat chisel shown in FIG. 10. FIG. 12 shows a side view from the right of the flat chisel 2 shown in FIG. 10. FIG. 13 shows a plan view of the flat chisel 2 shown in FIG. 12.

FIG. 14 shows a main lip 7 of a flat chisel 2 not shown in any more detail. The main lip 7, as viewed in cross section or from the side, is designed as a ramp 24 and has a cutting face 9 [sic] running parallel to a chisel longitudinal axis x and a cutting face 8 [sic] running at an angle thereto. According to an embodiment variant which is not shown, provision is also made for the side lips to be designed in a ramp shape.

The invention is not restricted to exemplary embodiments shown and described. On the contrary, it comprises developments of the invention within the scope of the patent claims.

### List of Designations:

1 Chisel

1′ Chisel (prior art)

2 Flat chisel

3 Chisel head

4 Chisel shank

5 Clamping shank

6 SDS-plus clamping shank

7 Main lip

8 Front cutting face

9 Rear cutting face

10 Front striking face

11 Rear striking face

12 Right-hand side face

13 Left-hand side face

14 Right-hand side lip

15 Left-hand side lip

16 Cutting face of 14, 15

17 Cutting edge

17a Cutting edge

17b Cutting edge

18 Cutting edge

19 Transition region

20 Cutting edge

21 Separating edge

22 Gable

23 Gable face

24 Ramp

1. Flat chisel (2), in particular an insertion chisel for power-driven rotary hammers for working stone, having a chisel head (3) which has a main lip (7) disposed approximately transversely to a chisel longitudinal axis (x), a front and a rear striking face (10, 11), and at least one side face (12, 13) connecting the striking face (10, 11), characterized in that the main lip (7) and/or a side face (12, 13) designed as a side lip (14, 15) has an approximately concave and/or convex and/or bent and/or undulating profile.

2. Flat chisel according to claim 1, characterized in that at least one side lip (14, 15) merges into the main lip (7).

3. Flat chisel according to one of the preceding claims, characterized in that the main lip (7) and the side lip (14, 15) have cutting edges (20, 17, 18) which lie in a common plane (E).

4. Flat chisel according to one of the preceding claims, characterized in that the main lip (7) and/or the side lip (14, 15) are designed to be gable-shaped (22) and/or ramp-shaped (24) in cross section.

5. Flat chisel according to claim 5, characterized in that the main lip (7) runs so as to be bent in a U shape toward the chisel shank (4).

6. Flat chisel according to claim 5, characterized in that the main lip (7) runs so as to be bent in a V shape toward the chisel shank (4).

7. Flat chisel according to claim 5, characterized in that the side lip (14, 15) runs so as to be bent in a tub shape relative to the chisel longitudinal axis (x).
